(19) United States
(12) Patent Application Publication
(10) Pub. No.: US 2005/0193655 A1
(43) Pub. Date: Sep. 8, 2005

(54) Method of forming a glazed door, and glazed door

(76) Inventors: David Paxton, Warmsworth (GB); Andrew J. Horsfall, Middleton Leeds (GB); Michael James Teal, Wickersley (GB)

Correspondence Address: BERENATO, WHITE & STAVISH, LLC, 6550 ROCK SPRING DRIVE, SUITE 240, BETHESDA, MD, 20817, US

(21) Appl. No.: 10/981,744

(22) Filed: Nov. 5, 2004

(30) Foreign Application Priority Data
Nov. 6, 2003 (EP) 03257017.8-1255
Sep. 21, 2004 (EP) 04255736.3

(51) Int. Cl. E06B 7/00; E06B 1/04; E04C 3/30

(52) U.S. Cl. 52/204.591

(57) ABSTRACT

The present invention is directed to a glazed door having a peripheral doorframe, and first and second door facings secured to opposing sides of the doorframe. Each door facing has an opening. A saddle is secured to the first and second door facings, and surrounds the opening. A first glazing bead is secured to a first receiving portion of the saddle. A second glazing bead is secured to a second receiving portion of the saddle. A glazing panel is secured within the opening between the first and second glazing beads. A method of forming the glazed door is also disclosed.

### CLAIM TO PRIORITY

This application claims priority to application number 03257017.8-1255, filed Nov. 6, 2003 and application number 04255736.3 filed Sep. 21, 2004 in the European Patent Office, the disclosure of which is incorporated herein by reference.

### FIELD OF THE INVENTION

The present invention is directed to a glazed door having a peripheral doorframe, and first and second door facings secured to opposing sides of the doorframe. Each door facing has an opening. A saddle is secured to the first and second door facings, and surrounds the opening. A first glazing bead is secured to a first receiving portion of the saddle. A second glazing bead is secured to a second receiving portion of the saddle. A glazing panel is secured within the opening between the first and second glazing beads. A method of forming the glazed door is also disclosed.

### BACKGROUND OF THE INVENTION

As known in the art, door facings may be secured to a support structure or frame to form a hollow core door. Such facings may be molded from a planar cellulosic mat, which typically includes cellulosic fibers or particles and a resin binder. The mat may be molded to include one or more depressions or grooves, such as one or more square or rectangular depressions. These depressions may define the perimeter of one or more simulated panels. Alternatively, the facings may be flush.

It is sometimes desirable for such doors to have a glazing unit, frequently provided in the form of a cassette. A cassette is a framed window assembly adapted to be mounted to a door. In addition to a perimeter frame, the door facings are secured to a window frame. A portion of each door facing is routed or cut out in an area corresponding to the area defined by the window frame. The cassette is mounted within the window frame, and secured to the window frame using screws, pins, or the like.

Various cassette designs have been developed. Many designs comprise first and second halves that hold a glass unit. The first halve of the cassette is positioned against one facing. The glass is then placed in position, and the second halve is positioned against the opposing facing, sandwiching the glass therebetween. The cassette is then secured in place on the door using pins or screws.

Cassettes typically are bulky, having a thickness greater than the thickness of the doorframe. As such, cassettes often protrude outwardly from the exteriorly disposed surfaces of the door facings. The cassette on such a glazed door may be easily damaged, particularly during transit, given it protrudes from the exterior plane of the door facings. The fasteners used to secure the cassette to the door are usually visible and can be unsightly.

Glazed doors having conventional glazing units are relatively expensive to manufacture. Such doors must be specially made with an internal window frame. The cassette halves are typically fragile, and must be stored and handled with care to avoid damage. The cassette halves and glass unit must be carefully positioned and secured with pins or screws, thereby increasing labor costs for such doors.

Therefore, there is a need for a glazed door, and a method of making a glazed door, that is cost efficient, aesthetically pleasing to consumers and allows glass to be retrofitted to a standard hollow core door.

### SUMMARY OF THE INVENTION

The present invention is directed to a glazed door. The glazed door includes a peripheral doorframe, and first and second door facings secured to opposing sides of the doorframe. Each door facing has an opening. A saddle is secured to the first and second door facings, and surrounds the opening. A first glazing bead is secured to a first receiving portion of the saddle. A second glazing bead is secured to a second receiving portion of the saddle. A glazing panel is secured within the opening between the first and second glazing beads.

The present invention also relates to a method of forming a glazed door. A door is provided having first and second door facings secured to opposing sides of a peripheral doorframe. Each of the facings has a panel portion. The panel portion is removed from each of the facings to form an opening in the door. A saddle is secured to the door facings surrounding the opening. A first glazing bead is secured to a first receiving portion of the saddle. A glazing panel is positioned within the opening and against the first glazing bead. A second glazing bead is secured to a second receiving portion of the saddle so that the glazing panel is secured between the first and second glazing beads.

### BRIEF DESCRIPTION OF THE FIGURES

FIG. 1 is a front elevational view of a glazed door according to a first embodiment of the present invention;

FIG. 2 is a fragmentary cross-sectional view of the glazed door of FIG. 1 taken along line 2-2 and viewed in the direction of the arrows;

FIG. 3 is a side elevational view of a saddle according to the first embodiment;

FIG. 4 is a side elevational view of a glazing bead according to the first embodiment;

FIG. 5 is a fragmentary side elevational view of a glazing panel secured between the saddle and glazing beads according to the first embodiment;

FIG. 6 is a front plan view of a door having an opening;

FIG. 7 is a fragmentary cross-sectional view of a door having a panel defined by a molded portion;

FIG. 7A is a fragmentary cross-sectional view of the circled portion 7-7 of the door of FIG. 6;

FIG. 8 is a front plan view of a door with portions broken away showing a honeycomb core;

FIG. 9 is a fragmentary cross-sectional view of a door having an opening;

FIG. 10 is a fragmentary cross-sectional view of the door of FIG. 9 with the saddle according to the first embodiment surrounding the opening;

FIG. 11 is a fragmentary cross-sectional view of the door of FIG. 10 with a glazing panel positioned on the saddle and a glazing bead according to the first embodiment;

FIG. 12 is fragmentary cross-sectional view of a glazed door with the glazing panel of FIG. 11 secured between the saddle and the glazing bead;

FIG. 13 is a fragmentary cross-sectional view of a glazed door according to a second embodiment;

FIG. 14 is a side elevational view of a saddle according to the second embodiment;

FIG. 15 is a side elevational view of glazing beads according to the second embodiment;

FIG. 16 is a fragmentary cross-sectional view of a door having an opening with the saddle according to the second embodiment surrounding the opening;

FIG. 17 is a fragmentary cross-sectional view of the door of FIG. 16 with a first glazing bead according to the second embodiment secured to the saddle;

FIG. 18 is a fragmentary cross-sectional view of the door of FIG. 17 with a glazing panel positioned against the saddle and first glazing bead; and

FIG. 19 is fragmentary cross-sectional view of a glazed door according to the second embodiment.

### DETAILED DESCRIPTION OF THE INVENTION

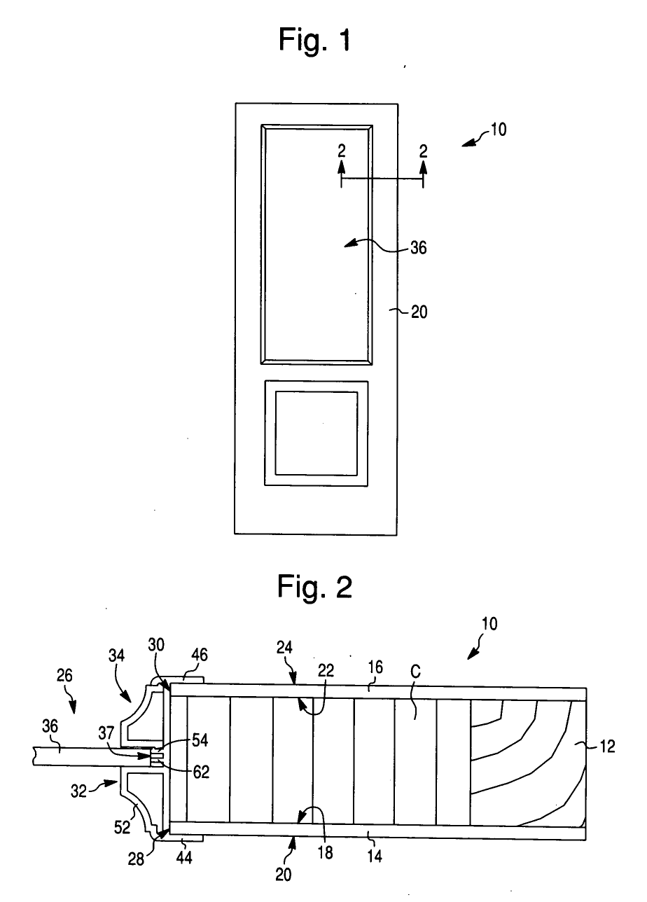

As best shown in FIGS. 1 and 2, a glazed door 10 according to a first embodiment of the present invention comprises a peripheral frame 12, and first and second door facings 14, 16. Facing 14 includes an interior surface 18 and an exterior surface 20. Likewise, facing 16 includes an interior surface 22 and an exterior surface 24. Interior surfaces 18, 22 are secured to opposing sides of peripheral frame 12 by adhesive or the like. At least one opening 26 extends through facings 14, 16. Opening 26 is defined by a first edge 28 of first facing 14 and a second edge 30 of second facing 16. A saddle 32 extends from first edge 28 of first facing 14 to second edge 30 of second facing 16. A lazing bead 34 is secured to saddle 32. A glazing panel 36, such as a glass pane, is secured between saddle 32 and glazing bead 34 within opening 26. Door 10 may also include a core C disposed between first and second door facings 14, 16. Core C is preferably a paper honeycomb core material.

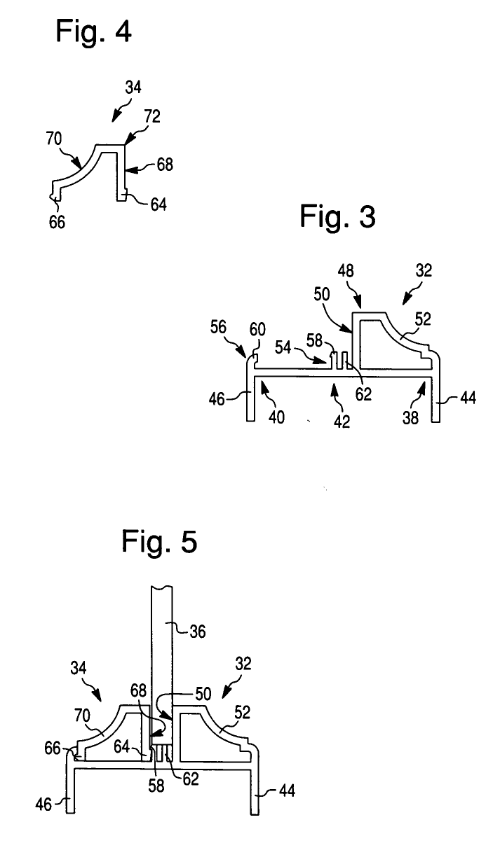

As best shown in FIGS. 2 and 3, saddle 32 includes first and second ends 38, 40, and a central planar portion 42 intermediate first and second ends 38, 40. A first leg 44 extends outwardly from first end 38, away from opening 26, and onto exterior surface 20 of first facing 14, as best shown in FIG. 2. A second leg 46 extends outwardly from second end 40, away from opening 26, and onto exterior surface 24 of second facing 16. First leg 44 is preferably substantially parallel to second leg 46, and first and second legs 44, 46 are preferably substantially perpendicular to central portion 42.

First and second legs 44, 46 are preferably flush with, and grip, exterior surfaces 20, 24 of first and second facings 14, 16, respectively, thereby securing saddle 32 in place around opening 26. An adhesive, such as polyvinyl acetate, may also be used to secure saddle 32 in place. However, first and second legs 44, 46 are preferably configured such that saddle 32 may be securely fitted in place without the use of an adhesive or other fastening means. In this way, saddle 32 may be quickly and easily clipped around opening 26 during manufacture of glazed door 10. To ensure a secure fit, legs 44, 46 should be spaced from each other a distance that is substantially equal to the thickness of door 10. In addition, legs 44, 46 should extend onto exterior surfaces 20, 24 a sufficient amount to securely grip facings 14, 16.

Saddle 32 also includes an integral glazing bead 48 extending outwardly into opening 26. Glazing bead 48 includes an inner surface 50 extending from central portion 42, which abuts one side of glazing panel 36. Glazing bead 48 may include a contoured portion 52, though a planar angular side may also be provided. Contoured portion 52 may provide additional support to inner surface 50. Alternatively, inner surface 50 may have sufficient thickness so that no additional structural support by contoured portion 52 is required. Contoured portion 52 preferably extends from first end 38 to inner surface 50. Contoured portion 52 preferably is configured to enhance the decorative appearance of door 10. It should be understood that the configuration of contoured portion 52 might vary. However, contoured portion preferably does not extend outwardly beyond the plane of exterior surfaces 20, 24 to reduce the possibility of damaging the glazing system. In this way, any damage to doors 10 during transport, or when stacked, is minimized.

Saddle 32 also includes an inner clip 54 and an outer clip 56. Inner clip 54 extends outwardly from central portion 42 into opening 26, and is proximate inner surface 50. Clips 54 and 56 preferably extend parallel to inner planar surface 50. Outer clip 56 extends into opening 26, and is proximate second end 40. Outer clip 56 may be coplanar with second leg 46. Inner and outer clips 54, 56 preferably include hooked ends 58, 60, respectively, which curve inwardly toward each other.

Saddle 32 may also include a central stud 62, which extends outwardly into opening 26, as best shown in FIGS. 2 and 3. Stud 62 is intermediate inner surface 50 and inner clip 54. Preferably, the length of stud 62 is substantially equal to the length of inner clip 54. In this way, a peripheral edge 37 of glazing panel 36 rests against both stud 62 and the top of inner clip 54, as best shown in FIG. 2.

Saddle 32 is preferably formed of plastic, such as polyvinyl chloride, in order to provide sufficient flexibility to allow saddle 32 to be clipped into place about opening 26 and yet have sufficient rigidity to maintain glazing panel 36 secured during use of door 10. In addition, all of the components of saddle 32 are preferably integrally formed. It should be understood that the precise dimensions of saddle 32 may vary depending on the dimensions and thickness of door 10, as well as the dimensions and thickness of glazing panel 36. Further, the dimensions of saddle 32 may vary depending on the material used to form saddle 32. Glazing bead 48 preferably extends into opening 26 a sufficient distance so that inner surface 50 provides sufficient support to glazing panel 36. Legs 44, 46 should be sufficiently spaced, and have a sufficient length, so that saddle 32 grips facings 14, 16.

As best shown in FIG. 4, glazing bead 34 may include a first hooked end 64 and a second hooked end 66. First and second hooked ends 64, 66 are configured and spaced to engage and snap-fit with inner and outer clips 54, 56, respectively. Glazing bead 34 includes a second inner surface 68, which is adjacent glazing panel 36. In this way, opposing sides of glazing panel 36 are secured between inner surface 50 of saddle 32, and second inner surface 68 of glazing bead 34, as best shown in FIG. 5. The edge 37 of glazing panel 36 is preferably supported by stud 62.

Glazing bead 34 may also include a second contoured portion 70, which preferably corresponds to the configuration of contoured portion 52, as best shown in FIGS. 2-5. Glazing bead 34 may also include an inner surface tip 72 extending outwardly from second inner surface 68. After securing glazing bead 34 to saddle 32, tip 72 is tensioned against glazing panel 36, thereby ensuring a tight fit for glazing panel 36 on door 10 and minimizing any rattling. Because glazing panel 36 is supported by stud 62, inner clip 54 is not bent by glazing panel 36 when glazing panel 36 is positioned on door 10. In this way, the engaging members (i.e. first hooked end 64 and hooked end 58 of inner clip 54) securely lock together so that second inner surface 68 either abuts, or is relatively close to, glazing panel 36. The effects of any gap between second inner surface 68 and glazing panel 36, if any, are negated by tensioned tip 72, as best shown in FIG. 5.

Glazing bead 34 is preferably formed of plastic, such as polyvinyl chloride. As with saddle 32, the precise dimensions of glazing bead 34 may vary depending on the dimensions of door 10 and glazing panel 36, as well as the material used to form glazing bead 34.

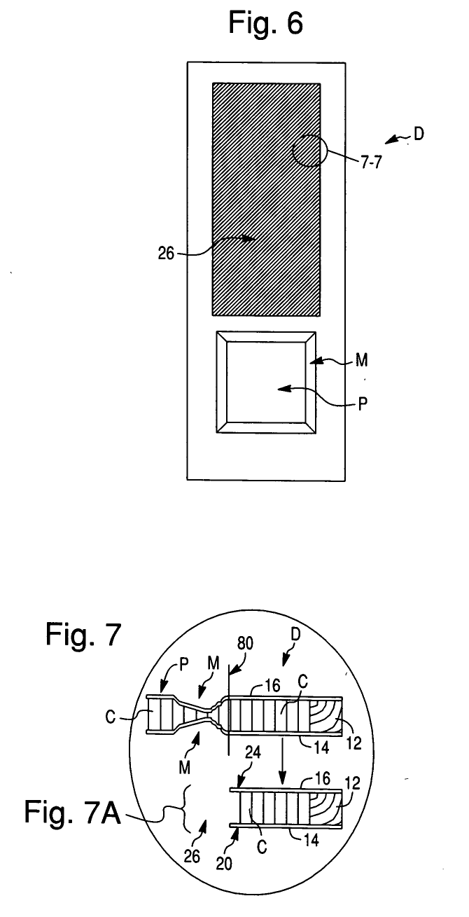

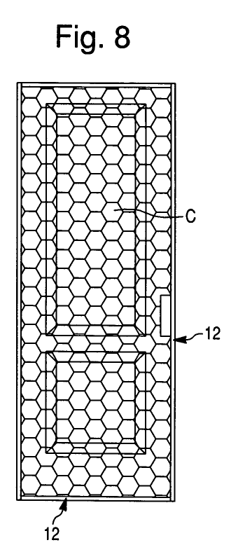

The present invention is also directed to a method of forming a glazed door, such as glazed door 10. As best shown in FIGS. 6, 7 and 7A, a hollow core door D is provided. Door D includes first and second door facings 14, 16, which are secured to opposing sides of perimeter frame 12. As best shown in FIG. 8, door D preferably includes a paper honeycomb core C disposed within frame 12 and between facings 14, 16 (facing 16 is not shown in FIG. 8 to illustrate core C). Door D includes at least one panel portion P, as best shown in FIG. 7. One or more panel portions P are removed from each facing 14, 16, along with any core C material therebetween, to form opening 26, as best shown in FIGS. 6 and 7A. Panel portions P on each facing 14, 16 are defined by molded portions M, which are preferably entirely removed along a cut line 80 to form opening 26 through door D, as best shown in FIGS. 7 and 7A.

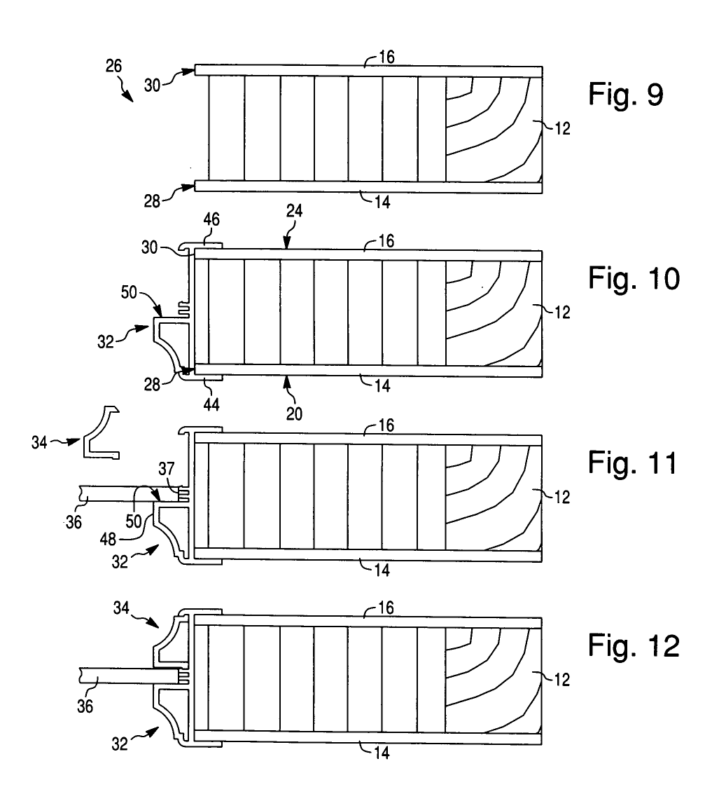

Glazing panel 36 may then be secured to door D within opening 26 using saddle 32 and glazing bead 34, as best shown in FIGS. 9-12. As best shown in FIG. 9, opening 26 is defined by first edge 28 of facing 14, and second edge 30 of facing 16. Saddle 32 is secured to facings 14, 16 around opening 26, as shown in FIG. 10. Specifically, legs 44, 46 are slid past first and second edges 28, 30, and onto exterior surfaces 20, 24, respectively. Although legs 44, 46 slide over exterior surfaces 20, 24, saddle 32 is preferably configured to provide a relatively tightly fit against facings 14, 16. Further, saddle 32 is sufficiently rigid so that legs 44, 46 do not bend away from facings 14, 16.

Next, glazing panel 36 is positioned against inner surface 50 of glazing bead 48 on saddle 32, as best shown in FIG. 11. The edge 37 of glazing panel 36 rests against stud 62 and inner clip 54. Stud 62 and inner clip 54 are preferably the same length. After glazing panel 36 has been positioned against saddle 32, glazing bead 34 is secured to saddle 32, as best shown in FIG. 12. First and second hooked ends 64, 66 engage inner and outer clips 54, 56, respectively, to securely lock glazing bead 34 in place, as best shown in FIGS. 5 and 12. Glazing panel 36 is thereby secured between inner surface 50 of saddle 32 and second inner surface 68 of glazing bead 34. Tip 72 is tensioned against glazing panel 36, thereby ensuring a tight fit for glazing panel 36 and minimizing any rattling.

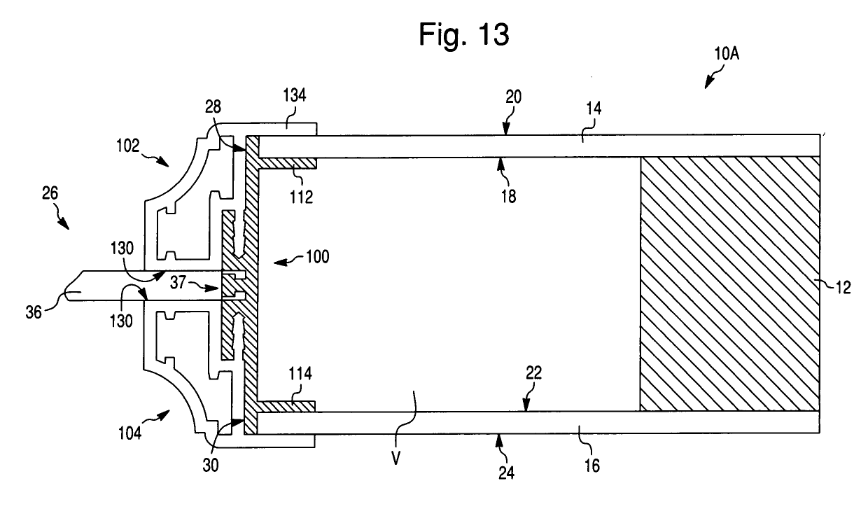

A glazed door 10A according to a second embodiment is best shown in FIGS. 13 and 19. As in the first embodiment, door 10A comprises peripheral frame 12, and first and second door facings 14, 16. Interior surfaces 18, 22 of facings 14, 16 are secured to opposing sides of peripheral frame 12 by adhesive or the like. At least one opening 26 extends through facings 14, 16. Opening 26 is defined by first edge 28 of first facing 14 and second edge 30 of second facing 16.

Glazed door 10A includes a saddle 100, which extends from first edge 28 of first facing 14 to second edge 30 of second facing 16. Glazing beads 102, 104 are secured to saddle 100. Edge 37 of glazing panel 36 abuts saddle 100. Panel 36 is secured within opening 26 between glazing beads 102, 104. Door 10A may include a core material, such as in the first embodiment, disposed between first and second door facings 14, 16. Alternatively, door 10A may include a void V between first and second door facings 14, 16.

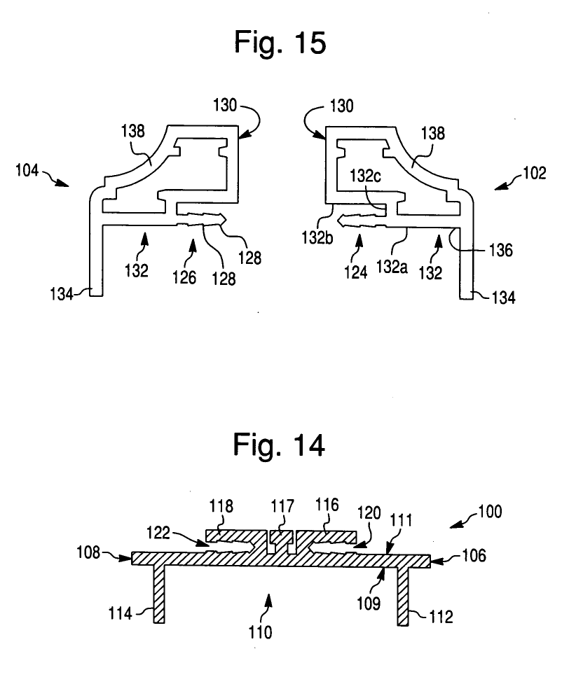

As best shown in FIGS. 13 and 14, saddle 100 includes first and second ends 106, 108, and a central portion 110 intermediate and integral with first and second ends 106, 108. Central portion 110 includes first and second opposing sides 109, 111. A first leg 112 extends outwardly from first side 109 proximate first end 106. First leg 112 extends outwardly away from opening 26, and is adjacent interior surface 18 of first facing 14 when saddle 100 is secured to facings 14, 16, as best shown in FIG. 13. A second leg 114 extends outwardly from first side 109 proximate second end 108. Second leg 114 extends outwardly away from opening 26, and is adjacent interior surface 22 of second facing 16 when saddle 100 is secured to facings 14, 16. First leg 112 is preferably substantially parallel to second leg 114, and first and second legs 112, 114 are preferably substantially perpendicular to first side 109 of central portion 110.

First and second legs 112, 114 are preferably flush with and grip interior surfaces 18, 22, respectively, when secured thereon, thereby securing saddle 100 in place around opening 26. First and second legs 112, 114 are also preferably spaced from first and second ends 106, 108, respectively, a distance substantially equal to the width of first and second edges 28, 30 of facings 14, 16. In this way, first end 106 of saddle 100 is substantially flush with exterior surface 20 of facing 14, and second end 108 is substantially flush with exterior surface 24 of facing 16.

An adhesive, such as polyvinyl acetate, may be used to secure saddle 100 to facings 14, 16. However, first and second legs 112, 114 are preferably configured and spaced from each other such that saddle 100 may be securely fitted in place against facings 14, 16 without the use of an adhesive or other fastening means. In this way, saddle 100 may be quickly and easily clipped around opening 26 during manufacture of glazed door 10A.

Saddle 100 includes first and second receiving portions 116, 118 extending outwardly from second side 111 of central portion 110. First receiving portion 116 includes a first stepped bore 120 extending therein, and second receiving portion 118 includes a second stepped bore 122 extending therein.

Saddle 100 may also include a central stud 117, which extends outwardly into opening 26 from second side 111 of central portion 110. Stud 117 is intermediate first and second receiving portions 116, 118. Stud 117 and first and second receiving portions 116, 118 preferably extend outwardly from second side 111 of central portion 110 substantially the same distance, as best shown in FIGS. 13 and 14.

As best shown in FIGS. 13 and 15, glazing beads 102, 104 include stepped prongs 124, 126, respectively. First and second bores 120, 122 are configured to receive and secure prongs 124, 126 therein. Preferably, prongs 124, 126 include barbs 128, and bores 120, 122 are configured to receive barbed prongs 124, 126, respectively. In this way, prongs 124, 126 may be pushed into bores 120, 122, thereby securing glazing beads 102, 104 to saddle 100 without the use of adhesive. Of course, glazing beads 102, 104 may also be secured to saddle 100 using an adhesive.

Glazing bead 102 includes a first inner wall 130 which abuts one side of glazing panel 36, and a stepped second inner wall 132. Second inner wall 132 includes a first portion 132a which abuts second side 111 of saddle 100, and a second portion 132b which abuts first receiving portion 116. First and second portions 132a, 132b are preferably parallel to and spaced from each other. A ledge 132c extends between first and second portions 132a, 132b. Preferably, prong 124 extends outwardly from ledge 132c and is inwardly disposed relative to inner wall 130. Prong 124 is also preferably parallel to first and second portions 132a, 132b.

Glazing bead 102 may also include an outer leg 134 that extends outwardly from an end 136 of first portion 132a. Outer leg 134 extends outwardly and away from opening 26, and is adjacent exterior surface 20 of first facing 14 when glazing bead 102 is secured to saddle 100, as best shown in FIG. 13. Outer leg 134 is preferably flush with and grips exterior surface 20 when barbed prong 124 is secured within first opening 120. In this way, facing 14 is sandwiched between first leg 112 of saddle 100 and outer leg 134 of glazing bead 102.

Glazing bead 102 also preferably includes a contoured portion 138 extending between end 136 and first inner wall 130. Contoured portion 138 is preferably configured to enhance the decorative appearance of door 10A. However, a planar angular side may also be provided between end 136 and first inner wall 130. Furthermore, the configuration of contoured portion 138 may vary depending on consumer preference. However, contoured portion 138 preferably does not extend outwardly beyond the plane of exterior surface 20 to reduce the possibility of damaging the glazing system.

Glazing bead 104 preferably has an identical configuration to glazing bead 102. Accordingly, like components of glazing beads 102, 104 are identified with identical reference numerals, and a description of same will not be repeated hereafter. Note that prong 126 preferably has an identical configuration to prong 124, but is received in bore 122. In this way, glazing panel 36 is secured between first inner wall 130 of glazing bead 102 and first inner wall 130 of glazing bead 104, as best shown in FIGS. 13 and 19. Edge 37 of glazing panel 36 preferably abuts and is supported by stud 117.

As in the first embodiment, saddle 100 is preferably formed of plastic, such as polyvinyl chloride, and is sufficiently flexible to allow barbed prongs 124, 126 to be inserted into bores 120, 122, respectively. In addition, all of the components of saddle 100 preferably are integrally formed. The precise dimensions of saddle 100 may vary depending on the dimensions and thickness of door 10A, as well as the dimensions and thickness of glazing panel 36. Likewise, glazing beads 102, 104 are also preferably formed of plastic, such as polyvinyl chloride. The precise dimensions of glazing beads 102, 104 may also vary depending on the dimensions of door 10A and glazing panel 36, as well as the material used to form glazing beads 102, 104.

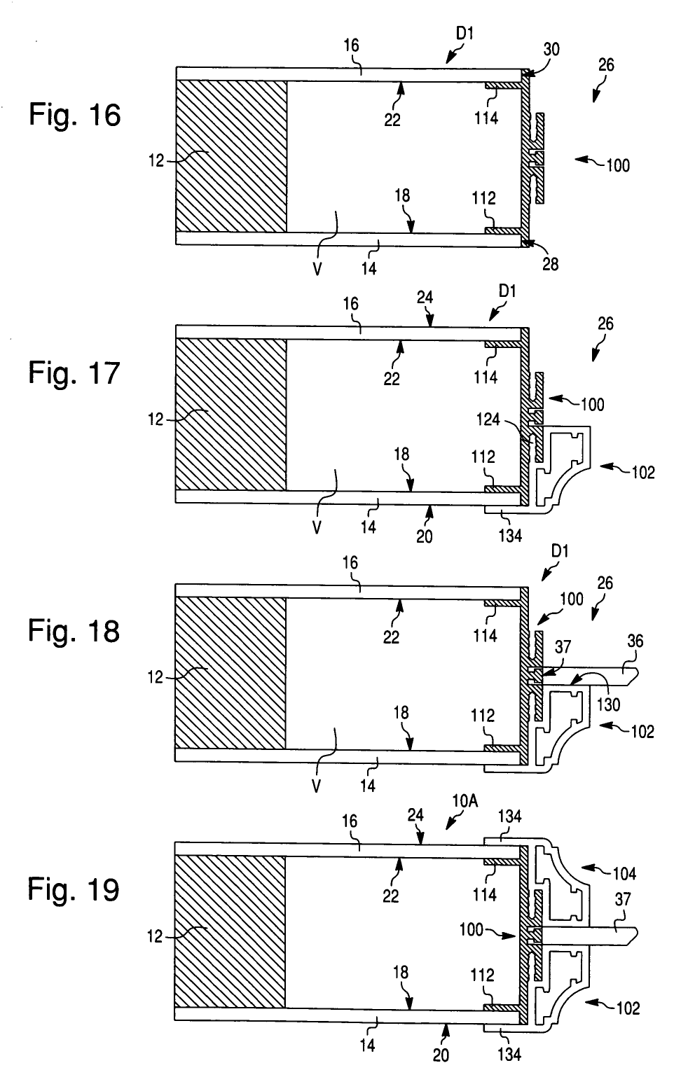

A method of forming glazed door 10A is described with reference to FIGS. 16-19. A hollow core door D1 is provided. As in the first embodiment, door D1 includes first and second door facings 14, 16, which are secured to opposing sides of perimeter frame 12. At least one opening 26 is formed in door D1 by removing one or more panel portions, as described above.

As best shown in FIG. 16, saddle 100 is secured within opening 26 by inserting first and second legs 112, 114 into void V so that legs 112, 114 slide against interior surfaces 18, 22 of facings 14, 16, respectively. Legs 112, 114 are pushed into void V until edges 28, 30 abut saddle 100.

Glazing bead 102 is then secured to saddle 100 by inserted prong 124 into first opening 120, as best shown in FIG. 17. Barbs 128 on prong 124 and the corresponding configuration of bore 120 ensure a tight fit. Prong 124 is pushed into bore 120 until outer leg 134 is flush with exterior surface 20 of facing 14. In addition, glazing bead 102 is configured so that first portion 132a and second portion 132b are flush with second side 111 and first receiving portion 118, respectively, as best shown in FIGS. 13 and 17.

As best shown in FIG. 18, glazing panel 36 is then positioned within opening 26. One side of panel 36 abuts first inner wall 130, and peripheral edge 37 preferably abuts, and is supported by, stud 117.

Glazing panel 36 may then be secured within opening 26 to form glazed door 10A by securing glazing bead 104 to saddle 100, as best shown in FIGS. 13 and 19. Prong 126 is pushed into opening 122 until outer leg 134 is flush with exterior surface 24 of facing 16. Prongs 124, 126 may be pushed into bores 120, 122, and secured therein due to barbs 128. In this way, a tight fit between glazing panel 36 and glazing beads 102, 104 is achieved.

Certain aspects of the present invention have been explained according to preferred embodiments. However, it will be understood to one of ordinary skill in the art that various modifications and variations can be made in construction or configuration without departing the scope or spirit of the invention. It is intended that the present invention include all such modifications and variations, provided they come within the scope of the following claims and their equivalents.

1. A glazed door, comprising:
a peripheral doorframe;
first and second door facings secured to opposing sides of said doorframe, each of said door facings having an opening;
a saddle secured to said first and second door facings, said saddle surrounding the opening;
a first glazing bead secured to said saddle;
a second glazing bead secured to said saddle; and
a glazing panel secured within said opening between said first and second glazing beads.

2. The glazed door of claim 1, wherein one of said glazing beads is integral with said saddle.

3. The glazed door of claim 2, wherein said saddle includes first and second ends interconnected by an intermediate central portion, spaced first and second legs extend outwardly from said central portion, said first leg proximate said first end and adjacent an interior surface of said first facing, said second leg proximate said second end and adjacent an interior surface of said second facing.

4. The glazed door of claim 3, wherein said first and second legs are parallel.

5. The glazed door of claim 3, wherein said first and second legs are substantially perpendicular to said central portion.

6. The glazed door of claim 3, wherein said first end is coplanar with an exterior surface of said first facing, and said second end is coplanar with an exterior surface of said second facing.

7. The glazed door of claim 1, wherein each of said glazing beads includes a prong secured within a bore formed in an associated receiving portion of said saddle.

8. The glazed door of claim 7, wherein said prongs are barbed.

9. The glazed door of claim 2, further comprising a central stud extending outwardly from said central portion into the opening.

10. The glazed door of claim 9, wherein said central stud is intermediate said first and second receiving portions.

11. The glazed door of claim 10, wherein said central stud and said first and second receiving portions extend outwardly from said central portion about the same distance.

12. The glazed door of claim 7, wherein said first and second glazing beads include first inner walls, said glazing panel secured between said first inner walls.

13. The glazed door of claim 12, wherein said first and second glazing beads include second inner walls, each of said second inner walls including a first portion adjacent said first and second receiving portions, respectively.

14. The glazed door of claim 13, wherein said first inner walls are substantially perpendicular to said second inner walls.

15. The glazed door of claim 14, wherein said prongs are substantially parallel to said second inner walls.

16. The glazed door of claim 13, wherein each of said first and second glazing beads includes an outer leg extending outwardly from an end of said second inner wall, said outer leg of said first glazing bead adjacent an exterior surface of said first facing, said outer leg of said second glazing bead adjacent an exterior surface of said second facing.

17. The glazed door of claim 16, wherein said outer legs are parallel to said spaced first and second legs of said saddle.

18. The glazed door of claim 13, wherein each of said first and second glazing beads further comprises a contoured portion extending between said first inner wall and said second inner wall.

19. The glazed door of claim 1, wherein said first and second glazing beads have an identical configuration.

20. The glazing door of claim 1, further comprising a core disposed between said first and second door facings.

21. The glazed door of claim 20, wherein said core is a paper honeycomb core.

22. The glazed door of claim 1, wherein said saddle is formed from polyvinyl chloride.

23. The glazed door of claim 1, wherein said glazing beads are formed from polyvinyl chloride.

24. A method of forming a glazed door, comprising the steps of:
providing a door comprising first and second door facings secured to opposing sides of a peripheral doorframe, each of the facings having a panel portion;
removing the panel portion from each of the facings to form an opening in the door;
securing a saddle to the door facings surrounding the opening;
securing a first glazing bead to a first receiving portion of the saddle;
positioning a glazing panel within the opening and against the first glazing bead;
securing a second glazing bead to a second receiving portion of the saddle so that the glazing panel is secured between the first and second glazing beads.
